(19) United States
(12) Patent Application Publication
(10) Pub. No.: US 2026/0151792 A1
(43) Pub. Date: Jun. 4, 2026

(54) SYSTEM AND METHOD FOR CURING A PIGMENTED ULTRAVIOLET CURABLE PAINT

(71) Applicant: GM Global Technology Operations LLC, Detroit, MI (US)

(72) Inventors: Hua-tzu Fan, Troy, MI (US); Dalong Gao, Rochester, MI (US); Michael Dziatczak, Shelby Township, MI (US); John Patrick Spicer, Plymouth, MI (US); Jorge F. Arinez, Rochester Hills, MI (US); Brittany Holmes, Berkley, MI (US)

(21) Appl. No.: 18/968,477

(22) Filed: Dec. 4, 2024

(51) Int. Cl. B05D 3/02; F26B 3/28

(52) U.S. Cl. CPC B05D 3/0254; F26B 3/28; F26B 2210/12

(57) ABSTRACT

A lamp housing to cure a pigmented ultraviolet (UV) curable paint includes a plurality of UV light emitting diode (LED) lights. The plurality of UV LED lights simultaneously emits light. The plurality of UV LED lights includes a first UV LED light and a second UV LED light. The first UV LED light emits a first wavelength and the second UV LED light emits a second wavelength. The first wavelength is different than the second wavelength. The lamp housing further includes a flexible substrate. The plurality of LED lights is disposed on the flexible substrate. The flexible substrate matches a contour of the pigmented UV curable paint.

### INTRODUCTION

The present disclosure generally relates to a system and method for curing an ultraviolet (UV) curable paint. More particularly, the present disclosure relates to a system and method for curing a pigmented UV curable paint with a lamp housing that contains UV light emitting diode (LED) lights.

Currently, UV curable paint is cured by broad-spectrum UV lamps such as a mercury-based UV lamp. A single wavelength UV LED light cannot cure UV curable paint. The root cause is that multiple wavelengths of the UV spectrum are required to thoroughly cure the pigmented UV curable paint. A long wavelength UV light is required to penetrate and cure a thickness of the pigmented UV curable paint. Meanwhile, a short wavelength UV light is required to penetrate and cure a skin of the pigmented UV curable paint.

Therefore, there is a need for a new and improved UV LED light system and method for curing the pigmented UV curable paint.

### SUMMARY

According to several aspects, a lamp housing to cure a pigmented ultraviolet (UV) curable paint is provided. The lamp housing includes a plurality of UV light emitting diode (LED) lights. The plurality of UV LED lights includes a first UV LED light. The first UV LED light emits a first wavelength. The plurality of UV LED lights also includes a second UV LED light. The second UV LED light emits a second wavelength. The first wavelength is different than the second wavelength. The plurality of UV LED lights simultaneously emits light. The lamp housing further includes a flexible substrate. The plurality of LED lights is disposed on the flexible substrate. The flexible substrate matches a contour of the pigmented UV curable paint.

In an additional aspect of the present disclosure, the first UV LED light is a UV-C LED light. The first wavelength is a UV-C wavelength that cures a surface of the pigmented UV curable paint.

In another aspect of the present disclosure, the second UV LED light is a UV-A LED light. The second wavelength is a UV-A wavelength that cures a thickness of the pigmented UV curable paint.

In another aspect of the present disclosure, the second UV LED light is a UV-V LED light. The second wavelength is a UV-V wavelength that cures a depth of the pigmented UV curable paint.

In another aspect of the present disclosure, the plurality of LED lights further comprises a third UV LED light. The third UV LED light is a UV-B LED light and emits a UV-B wavelength that cures a mid-layer of the pigmented UV curable paint.

In another aspect of the present disclosure, the lamp housing further comprises a rear actuator. The rear actuator controls the contour of the flexible substrate.

In another aspect of the present disclosure, the rear actuator maintains a desired distance between the plurality of LED lights and the pigmented UV curable paint.

According to several aspects, a robotic system to cure a pigmented ultraviolet (UV) curable paint is provided. The robotic system includes a robot arm. The robot arm includes a first end and a second end. The second end opposes the first end. The robotic system further includes a lamp housing disposed at the end of the second end of the robot arm. The lamp housing includes a plurality of UV light emitting diode (LED) lights disposed on a flexible substrate. The plurality of UV LED lights includes a first UV LED light. The first UV LED light emits a first wavelength. The plurality of UV LED lights further includes a second UV LED light. The second UV LED light emits a second wavelength. The first wavelength is different than the second wavelength. The plurality of UV LED lights simultaneously emits light. The robotic system further includes the flexible substrate. The flexible substrate matches a contour of the pigmented UV curable paint.

In another aspect of the present disclosure, the first UV LED light is a UV-C LED light. The first wavelength is a UV-C wavelength that cures a surface of the pigmented UV curable paint.

In another aspect of the present disclosure, the second UV LED light is a UV-A LED light. The second wavelength is a UV-A wavelength that cures a thickness of the pigmented UV curable paint.

In another aspect of the present disclosure, the second UV LED light is a UV-V LED light. The second wavelength is a UV-V wavelength that cures a depth of the pigmented UV curable paint.

In another aspect of the present disclosure, the plurality of UV LED lights further includes a third UV LED light. The third UV LED light is a UV-B LED light and emits a UV-B wavelength that cures a mid-layer of the pigmented UV curable paint.

In another aspect of the present disclosure, the robotic system further includes a rear actuator. The rear actuator controls the contour of the flexible substrate and maintains a desired distance between the plurality of UV LED lights and the pigmented UV curable paint.

In another aspect of the present disclosure, the robotic system further includes a control system. The control system includes determining the robot arm location and orientation relative to the pigmented UV curable paint, dynamically adjusting a duration and an intensity of each of the plurality of UV LED lights, and selectively turning on and turning off ones or sets of the plurality of UV LED lights.

According to several aspects, a method for curing a pigmented ultraviolet (UV) curable paint is provided. The method includes applying the pigmented UV curable paint to a substrate surface. The method further includes curing a first portion of the pigmented UV curable paint using a first UV light emitting diode (LED) light that emits a first wavelength. The method further includes curing a second portion of the pigmented UV curable paint using a second UV LED light that emits a second wavelength. The first wavelength is different than the second wavelength. The second portion of the UV curable paint is cured after the first portion of the UV curable paint is cured.

In another aspect of the present disclosure, the first UV LED light has a UV-C LED light. The UV-C LED light emits a UV-C wavelength that cures a skin of the UV curable paint.

In another aspect of the present disclosure, the second UV LED light has a UV-A LED light. The UV-V LED light emits a UV-V wavelength that cures a depth of the UV curable paint.

In another aspect of the present disclosure, the method further includes a third UV LED light that cures a mid-layer of the pigmented UV curable paint. The third UV LED light has a UV-B LED light and emits a UV-B wavelength. The UV-B wavelength is different than the first wavelength and different than the second wavelength. The mid-layer of the UV curable paint is cured after the first portion and before the second portion.

In another aspect of the present disclosure, the first UV LED light has a UV-V LED light. The UV-V LED light emits a UV-V wavelength that cures the depth of the UV curable paint.

In another aspect of the present disclosure, the second UV LED light has a UV-C LED light. The UV-C LED light emits a UV-C wavelength that cures the skin of the UV curable paint.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side view of a robot with a lamp housing mounted on the robot according to an exemplary embodiment.

FIG. 2A is a bottom view of the lamp housing with a plurality of UV LED lights according to an exemplary embodiment.

FIG. 2B is a bottom view of an alternate embodiment of the lamp housing with the plurality of UV LED lights according to an exemplary embodiment.

FIG. 3 is a side view of varying UV wavelengths penetrating a pigmented UV curable paint according to an exemplary embodiment.

FIG. 4 is an enlarged side view of an alternate embodiment of the lamp housing according to an exemplary embodiment.

FIG. 5 is a flowchart of a method for curing the pigmented UV curable paint according to an exemplary embodiment.

FIG. 6 is a flowchart of another method for curing the pigmented UV curable paint according to an exemplary embodiment.

FIG. 7 is a flowchart of another method for curing the pigmented UV curable paint according to an exemplary embodiment.

### DETAILED DESCRIPTION

The following description is merely exemplary in nature and is not intended to limit the present disclosure, application, or uses.

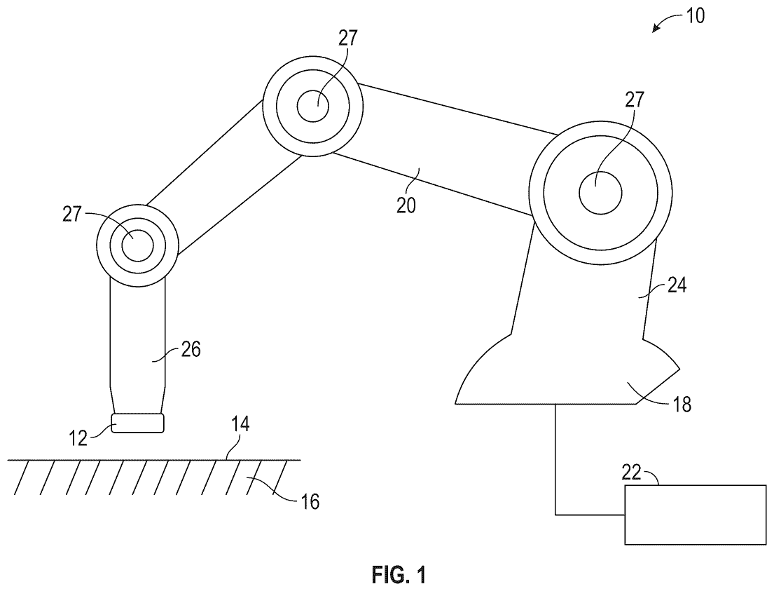

Referring to FIG. 1, a side view of a robot 10 with a lamp housing 12 according to the principles of the present disclosure is illustrated. It should be appreciated that the robot 10 may take various forms other than that shown in FIG. 1 without departing from the scope of the present disclosure. The robot 10 is programmed to cure a pigmented ultraviolet (UV) curable paint 14 applied to a substrate surface 16. The UV curable paint 14 may include primers, topcoats, adhesives, and nail polishes. The substrate surface 16 may include a vehicle part, such as a door, or any other item. The substrate surface 16 may also include an individual's nail and a construction material, such as a floor, wall or any other item. The robot 10 includes a base 18, a robot arm 20, and a controller 22.

The base 18 may be positioned on a floor surface (not shown) or on a stand (not shown). The robot arm 20 extends from a first end 24 to a second end 26. The second end 26 opposes the first end 24. The first end 24 is connected to the base 18 and the second end 26 is connected to the lamp housing 12. The robot arm 20 may include one or more joints 27 to allow the robot arm 20 to have one or more points of articulation.

The controller 22 may be disposed within the robot 10 or connected to the robot via a wired or wireless connection. The controller 22 is configured with a control system to operate the robot 10 and the lamp housing 12. For example, the controller 22 provides operational control signals, such as controlling a position of the robot arm 20, and controlling a distance between the lamp housing 12 and the pigmented UV curable paint 14. The controller 22 controls the robot arm 20 to move along a path over the substrate surface 16 and detects a distance between the pigmented UV curable paint 14 and the lamp housing 12.

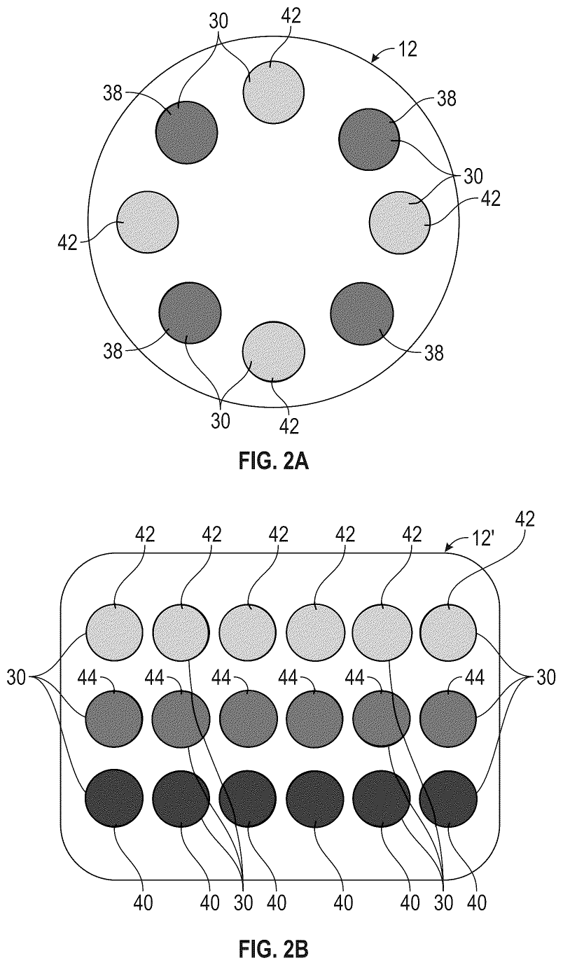

Referring to FIG. 2A, a bottom view of the lamp housing 12 is illustrated. The lamp housing 12 has a circular shape. A plurality of UV LED lights 30 are evenly around a perimeter of the lamp housing 12.

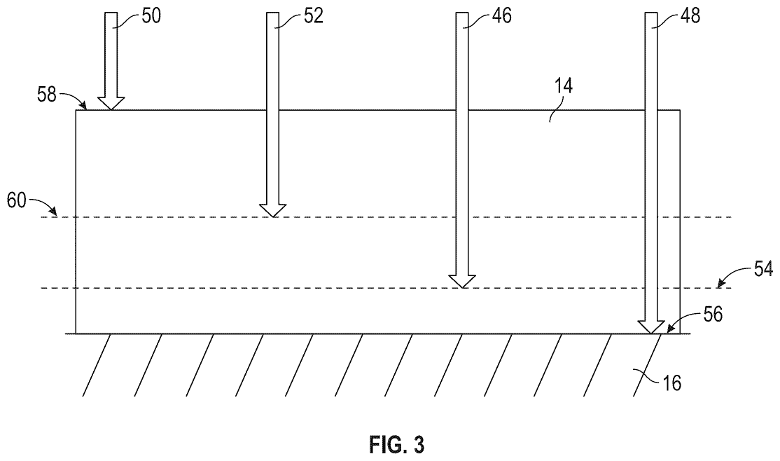

The plurality of UV LED lights 30 includes more than one UV LED light emitting more than one UV wavelength. The plurality of UV LED lights 30 may include a combination of two or more UV-A LED lights 38, UV-V LED lights 40, UV-C LED lights 42, and UV-B LED lights 44 to cure the pigmented UV curable paint 14 thoroughly. The election and combination of the two or more UV-A LED lights 38, UV-V LED lights 40, UV-C LED lights 42, and UV-B LED lights 44 are dependent on the pigmented UV curable paint's 14 curing requirements. In general, the UV-C LED lights 42 cure a skin 58 (shown in FIG. 3) of the pigmented UV curable paint 14 and create surface hardness and abrasion resistance. One or two additional types of UV-V LED lights 40, UV-A LED lights 38, or UV-B LED lights 44 are then selected to cure beneath the skin 58 (shown in FIG. 3) of the pigmented UV curable paint 14. In the example provided, the plurality of UV LED lights 30 in the lamp housing 12 includes UV-A LED lights 38 and UV-C LED lights 42. The UV-A LED lights 38 and UV-C LED lights 42 are arranged adjacent to one another and alternate around the perimeter of the lamp housing 12.

The plurality of UV LED lights is controlled by the controller (shown in FIG. 1). The controller 22 is configured with a control system to control a frequency of the plurality of LED lights 30, control an intensity of the plurality of UV LED lights 30, and control a duration of the plurality of UV LED lights 30. The controller 22 is programmed to detect a distance between the pigmented curable paint 14 and the plurality of the UV LED lights 30 in order to achieve a target intensity. The target intensity is achieved by the controller adjusting the intensity of the plurality of UV LED lights 30 or adjusting the distance between the UV curable paint 14 and the plurality of UV LED lights 30. The controller 22 is also configured with the control system to selectively turn on and off ones or sets of the plurality of UV LED lights 30.

Referring to FIG. 2B, an alternate embodiment of the lamp housing is indicated by reference number 12′. The lamp housing 12′ has a rectangular shape. The plurality of UV LED lights 30 are arranged in rows along a length of the lamp housing 12′. In the example provided, the plurality of UV LED lights 30 in the lamp housing 12′ includes the UV-C LED lights 42, the UV-B LED lights 44, and the UV-V LED lights 40. The UV-C LED lights 42, the UV-B LED lights 44, and the UV-V LED lights 40 are arranged in rows parallel to one another. Each row has one type of UV LED light and the type of UV LED light is different in each row.

Referring to FIG. 3, the UV wavelengths of the plurality of LED lights 30 is illustrated. The UV-A LED lights 38 emits a UV-A wavelength 46 ranging from about 320 nanometers (nm) to about 395 nm. The UV-V LED lights 40 emits a UV-V wavelength 48 ranging from about 395 nm to about 455 nm. The UV-C LED lights 42 emits a UV-C wavelength 50 ranging from about 200 nm to about 280 nm. The UV-B LED lights 44 emits a UV-B wavelength 52 ranging from about 280 nm to about 320 nm.

The UV-A wavelength 46, the UV-V wavelength 48, the UV-C wavelength 50, and the UV-B wavelength 52 cure different portions of the pigmented UV curable paint 14. The UV-A wavelength 46 cures a thickness 54 of the pigmented UV curable paint 14. The UV-V wavelength 48 cures a depth 56 of the pigmented UV curable paint 14. The UV-C wavelength 50 cures the skin 58 of the UV curable paint 14. The UV-B wavelength 52 cures a mid-layer 60 of the UV curable paint 14.

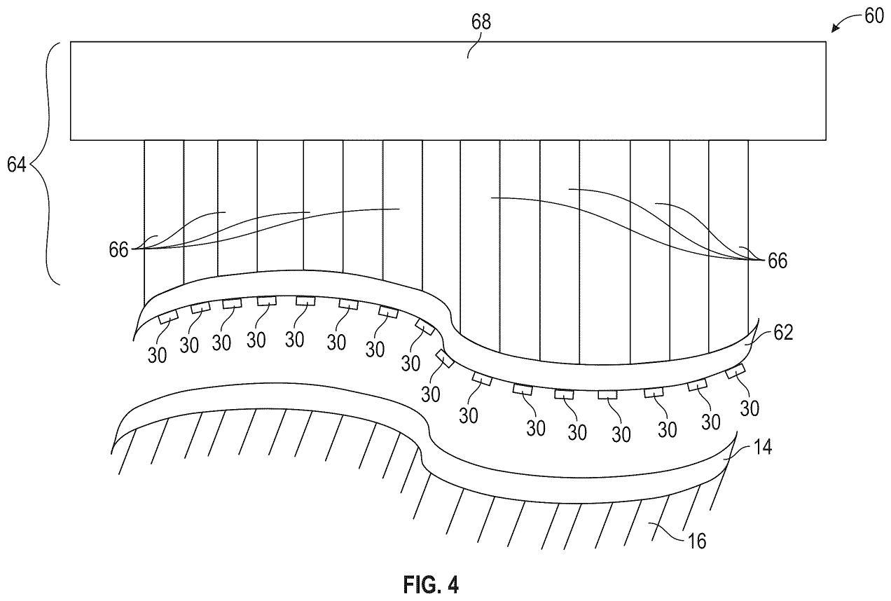

Referring to FIG. 4, an enlarged side view of an alternate embodiment of the lamp housing is illustrated and indicated by reference number 61. The lamp housing 61 may include an arrangement of the plurality of LED lights 30 as shown in FIGS. 2A and 2B. The lamp housing 61 also includes a flexible substrate 62 and a rear actuator 64. The plurality of UV LED lights 30 is disposed on the flexible substrate 62. The flexible substrate 62 is composed of a flexible material. Examples of the flexible material may include, but not limited to, fabric or plastic. In the example provided, the rear actuator 64 includes a plurality of pistons 66 that extend from a housing 68. Movement of the pistons 66 away and towards the housing 68 in turn changes a contour of the flexible substrate 62. The rear actuator 64 is controlled by the controller 22 (shown in FIG. 1) to create a rear force on the flexible substrate 62 that adjusts in real time. The rear force applied by the rear actuator 64 creates flexure and contouring of the flexible substrate 62 to form a desired shape. The desired shape of the flexible substrate 62 matches the contour of the substrate surface 16.

As the robot arm 20 moves the lamp housing 61 across the substrate surface 16, the contour of the substrate surface 16 may change. The controller 22 controls the robot arm 20 (shown in FIG. 1) to travel across and scan the substrate surface 16 to determine the desired shape in real time. The controller 22 then adjusts the rear force applied on the flexible substrate 62 to match the contour of the substrate surface 16.

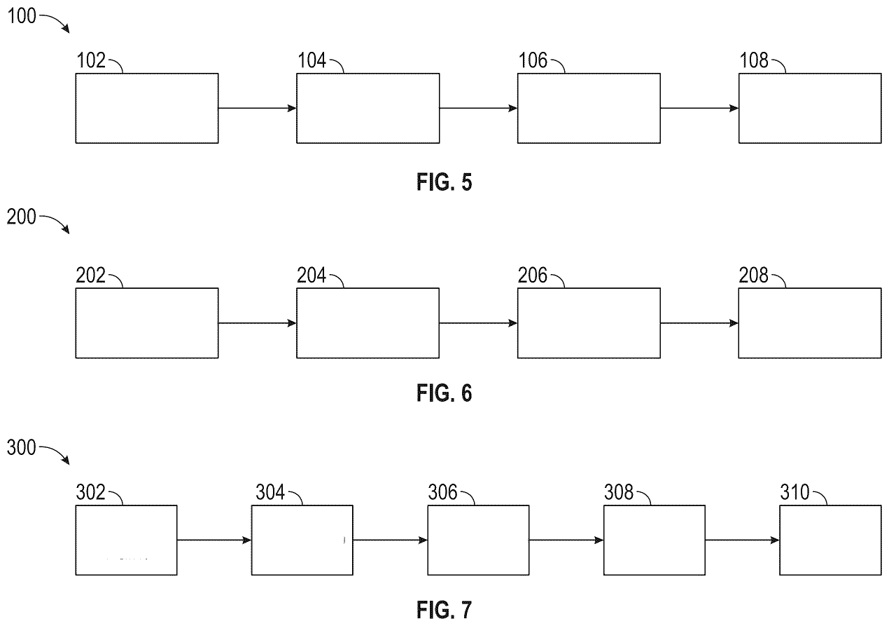

Referring to FIG. 5, a flowchart of a method 100 for curing the pigmented UV curable paint 14 is illustrated. The method 100 may employ the robot 10 and the lamp housings 12, 12′, 60 or use multiple robot arms each with a specific type of UV LED light. The method 100 begins at step 102, where the pigmented UV curable paint 14 is applied to the substrate surface 16. The method 100 proceeds to step 104.

At step 104, the UV-C LED light 42 is applied to the pigmented UV curable paint 14. The UV-C LED light 42 emits the UV-C wavelength 50 that penetrates and cures the skin 58 of the pigmented UV curable paint 14. The method 100 proceeds with step 106.

At step 106, the UV-A LED light 38 is applied to the pigmented UV curable paint 14. The UV-A LED light 38 emits the UV-A wavelength 46 that cures the thickness 54 of the pigmented UV curable paint 14. Alternatively, the UV-V LED light 40 is applied to the pigmented UV curable paint 14. The UV-V LED light 40 emits the UV-V wavelength 48 that cures the depth 56 of the pigmented UV curable paint 14. The method 100 then proceeds to step 108. At step 108, the method 100 ends with a fully cured pigmented UV curable paint 14.

Referring to FIG. 6, a flowchart of a method 200 for curing the pigmented UV curable paint 14 is illustrated. The method 200 begins at step 202, where the pigmented UV curable paint 14 is applied to the substrate surface 16. The method 200 proceeds with step 204. At step 204, the UV-V LED light 40 is applied to the pigmented UV curable paint 14. The UV-V LED light 40 emits the UV-V wavelength 48 that penetrates and cures the depth 56 of the pigmented UV curable paint 14. Alternatively, the UV-A LED light 38 is applied to the pigmented UV curable paint 14. The UV-A LED light 38 emits the UV-A wavelength 46 that penetrates and cures the thickness 54 of the pigmented UV curable paint 14. The method 200 proceeds to step 206.

At step 206, the UV-C LED light 42 is applied to the pigmented UV curable paint 14. The UV-C LED light 42 emits a UV-C wavelength 50 that cures the skin 58 of the pigmented UV curable paint 14. The method 200 proceeds with step 208. At step 208, the method 200 ends with a fully cured pigmented UV curable paint 14.

Referring to FIG. 7, a flowchart of a method 300 for curing a pigmented UV curable paint 14 is illustrated. The method 300 begins at step 302, where the pigmented UV curable paint 14 is applied to the substrate surface 16. The method 300 then proceeds to step 304. At step 304, the UV-C LED light 42 is applied to the pigmented UV curable paint 14. The UV-C LED light 42 emits the UV-C wavelength 50 that penetrates and cures the skin 58 of the pigmented UV curable paint 14. The method 300 proceeds to step 306. At step 306, the UV-B LED light 44 is applied to the pigmented UV curable paint 14. The UV-B LED light 44 emits the UV-B wavelength 52 that cures the mid-layer 60 of the pigmented UV curable paint 14. The method 300 proceeds to step 308.

At step 308, the UV-A LED light 38 is applied to the pigmented UV curable paint 14. The UV-A LED light 38 emits the UV-A wavelength 46 that cures the thickness 54 of the pigmented UV curable paint 14. Alternatively, the UV-V LED light 40 is applied to the pigmented UV curable paint 14. The UV-V LED light 40 emits the UV-V wavelength 48 that cures the depth 56 of the pigmented UV curable paint 14. The method 300 proceeds to step 310. At step 310, the method 300 ends with a fully cured pigmented UV curable paint 14.

The system and method to cure the pigmented UV curable paint 14 includes many advantages. The plurality of UV LED lights 30 are lighter and smaller, use less energy, and generate less heat than UV lamps. Additionally, the plurality of UV LED lights 30 emits various wavelengths to fully cure the pigmented UV curable paint 14 in one step. This creates a reduction in energy consumption, carbon emissions, production lead time, manufacturing footprint, and capital investments.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A lamp housing to cure a pigmented ultraviolet (UV) curable paint, the lamp housing comprising:
a plurality of UV light emitting diode (LED) lights, the plurality of UV LED lights including:
a first UV LED light, wherein the first UV LED light emits a first wavelength;
a second UV LED light, wherein the second UV LED light emits a second wavelength, and
wherein the first wavelength is different than the second wavelength,
wherein the plurality of UV LED lights simultaneously emits light; and
a flexible substrate, wherein the plurality of LED lights is disposed on the flexible substrate, and
wherein the flexible substrate matches a contour of the pigmented UV curable paint.

2. The lamp housing of claim 1, wherein the first UV LED light is a UV-C LED light, wherein the first wavelength is a UV-C wavelength that cures a surface of the pigmented UV curable paint.

3. The lamp housing of claim 1, wherein the second UV LED light is a UV-A LED light, wherein the second wavelength is a UV-A wavelength that cures a thickness of the pigmented UV curable paint.

4. The lamp housing of claim 1, wherein the second UV LED light is a UV-V LED light, wherein the second wavelength is a UV-V wavelength that cures a depth of the pigmented UV curable paint.

5. The lamp housing of claim 1, wherein the plurality of LED lights further comprises a third UV LED light, wherein the third UV LED light is a UV-B LED light and emits a UV-B wavelength that cures a mid-layer of the pigmented UV curable paint.

6. The lamp housing of claim 1, further comprising a rear actuator, wherein the rear actuator controls the contour of the flexible substrate.

7. The lamp housing of claim 6, wherein the rear actuator maintains a desired distance between the plurality of LED lights and the pigmented UV curable paint.

8. A robotic system to cure a pigmented ultraviolet (UV) curable paint, the robotic system comprising:
a robot arm including a first end and a second end, the second end opposing the first end;
a lamp housing disposed at the end of the second end of the robot arm, the lamp housing includes a plurality of UV light emitting diode (LED) lights disposed on a flexible substrate;
the plurality of UV LED lights including:
a first UV LED light, wherein the first UV LED light emits a first wavelength;
a second UV LED light, wherein the second UV LED light emits a second wavelength, and
wherein the first wavelength is different than the second wavelength,
wherein the plurality of UV LED lights simultaneously emits light; and
the flexible substrate, wherein the flexible substrate matches a contour of the pigmented UV curable paint.

9. The robotic system of claim 8, wherein the first UV LED light is a UV-C LED light, wherein the first wavelength is a UV-C wavelength that cures a surface of the pigmented UV curable paint.

10. The robotic system of claim 8, wherein the second UV LED light is a UV-A LED light, wherein the second wavelength is a UV-A wavelength that cures a thickness of the pigmented UV curable paint.

11. The robotic system of claim 8, wherein the second UV LED light is a UV-V LED light, wherein the second wavelength is a UV-V wavelength that cures a depth of the pigmented UV curable paint.

12. The robotic system of claim 8, wherein the plurality of UV LED lights further comprises a third UV LED light, wherein the third UV LED light is a UV-B LED light and emits a UV-B wavelength that cures a mid-layer of the pigmented UV curable paint.

13. The robotic system of claim 8, further comprising a rear actuator, wherein the rear actuator controls the contour of the flexible substrate and maintains a desired distance between the plurality of UV LED lights and the pigmented UV curable paint.

14. The robotic system of claim 8, further comprising a control system, the control system including:
determining the robot arm location and orientation relative to the pigmented UV curable paint;
dynamically adjusting a duration and an intensity of each of the plurality of UV LED lights; and
selectively turning on and turning off ones or sets of the plurality of UV LED lights.

15. A method for curing a pigmented ultraviolet (UV) curable paint, the method comprising:
applying the pigmented UV curable paint to a substrate surface;
curing a first portion of the pigmented UV curable paint using a first UV light emitting diode (LED) light that emits a first wavelength; and
curing a second portion of the pigmented UV curable paint using a second UV LED light that emits a second wavelength,
wherein the first wavelength is different than the second wavelength, and
wherein curing the second portion of the UV curable paint after curing the first portion of the UV curable paint.

16. The method of claim 15, wherein the first UV LED light has a UV-C LED light, wherein the UV-C LED light emits a UV-C wavelength, curing a skin of the UV curable paint.

17. The method of claim 15, wherein the second UV LED light has a UV-A LED light, wherein the UV-V LED light emits a UV-V wavelength, curing a depth of the UV curable paint.

18. The method of claim 15, further comprising a third UV LED light that cures a mid-layer of the pigmented UV curable paint,
wherein the third UV LED light has a UV-B LED light and emits a UV-B wavelength,
wherein the UV-B wavelength is different than the first wavelength and different than the second wavelength, and
wherein the mid-layer of the UV curable paint is cured after the first portion and before the second portion.

19. The method of claim 15, wherein the first UV LED light has a UV-V LED light, wherein the UV-V LED light emits a UV-V wavelength, curing the depth of the UV curable paint.

20. The method of claim 15, wherein the second UV LED light has a UV-C LED light, wherein the UV-C LED light emits a UV-C wavelength, curing the skin of the UV curable paint.
